(19) United States
(12) Patent Application Publication
(10) Pub. No.: US 2010/0063679 A1
(43) Pub. Date: Mar. 11, 2010

(54) Suspension with Adjustable Damping Force

(75) Inventors: Christian Maurischat, Euerbach (DE); Robert Pradel, Roethlein (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF FRIEDRICHSHAFEN AG, Friedrichshafen (DE)

(21) Appl. No.: 12/399,332

(22) Filed: Mar. 6, 2009

(30) Foreign Application Priority Data
Mar. 6, 2008 (DE) 10 2008 012 906.2

(51) Int. Cl. B60G 17/0185; B60G 17/015

(52) U.S. Cl. 701/39; 280/5.515

(57) ABSTRACT

In a suspension for a motor vehicle having at least one front axle and at least one rear axle, at least two vibration dampers which are separated from one another by a longitudinal axis of the vehicle are arranged at each axle. The sum of the occurring damping forces of the vibration dampers can be adjusted, and a vibration damper with adjustable damping force and a nonadjustable vibration damper are arranged at least at one vehicle axle.

### BACKGROUND OF THE INVENTION

1. Field of the Invention

The invention is directed to a suspension with adjustable damping force for a vehicle having a front axle, a rear axle, and a longitudinal axis separating the vibration dampers on each axle.

2. Description of the Related Art

Suspension with adjustable damping force is commonly used in top-of-the-line vehicles because customers accept the extra cost over conventional vibration dampers. Adjustable vibration dampers are also offered as an option in mid-range vehicles. In small cars, which are often used as second vehicles, there is currently no significant presence of electrically adjustable vibration dampers because the cost pressure is considerably higher. In this connection, it must be considered that a worn vibration damper will have to be replaced over the life of the vehicle and that a vibration damper with adjustable damping force cannot simply be replaced with a conventional construction since, e.g., an error message would be sent by the control device. Mechanically adjustable vibration dampers, e.g., vibration dampers which can be adjusted depending on distance or amplitude-dependent vibration dampers, are sometimes used so that good driving comfort along with safe driving characteristics can nevertheless be achieved.

### SUMMARY OF THE INVENTION

It is the object of the present invention to provide an economical solution for a suspension which should also meet increased demands respecting comfort and driving safety.

This object is met according to the invention by arranging a vibration damper with adjustable damping force and a nonadjustable vibration damper at least at one vehicle axle.

When only three adjustable vibration dampers, instead of four, and a nonadjustable vibration damper are used in a vehicle, the price of the system is reduced by at least 20%. The theoretical worsening of vehicle operation is not perceived by the average passenger in a vehicle.

A solution that goes even further is achieved by providing only two adjustable and two nonadjustable vibration dampers in a two-axle vehicle instead of four adjustable vibration dampers. These vibration dampers are constructed as adjustable and nonadjustable vibration dampers which are located diagonally opposite one another in the suspension with respect to the longitudinal axis of the vehicle so that all vehicle body movements such as pitching, rolling or lifting can be absorbed.

To partially dispense with adjustable vibration dampers, an operating procedure is applied, for which a sensor arrangement detects at least one driving state parameter and feeds it to a computer unit in which damping forces are determined on the basis of the at least one vehicle state parameter with respect to at least one driving state in order to achieve an aimed-for driving state, the damping forces of the at least one nonadjustable vibration damper being included as a damping force proportion in the damping force determination, and the adjustment of the adjustable vibration dampers is carried out while taking into account the damping force proportions of the at least one nonadjustable vibration damper. Finally, it is a question of limiting a vehicle body movement which is considered in turn as a horizontal orientation. In order to orient a plane, in this case a vehicle body, horizontally in relation to a second plane, namely, a roadway, four adjustable supports are not necessarily needed because a plane can be oriented by means of three supports or vectors. This insight is systematically implemented in the method.

Based on the at least one vehicle state parameter, the damping force of the at least one nonadjustable vibration damper is determined based on its damping force characteristic. For example, when the relative speed between the wheel and the vehicle body is selected as driving state parameter, it is possible to derive the associated damping force from this driving state parameter directly by means of the damping force characteristic which is fixed by design and is therefore known. The damping force is known not only as an amount but also as regards the direction so that a definitive damping force vector is available for determining the damping force adjustments of the adjustable vibration damper.

In another advantageous embodiment of the method, a damping force characteristic which corresponds to the minimum damping force performance is assumed for the nonadjustable vibration damper, and a decay behavior of an oscillatory motion of the vehicle can be determined from the driving status parameter, and this decay behavior is determined from a deviation from a reference decay behavior of the state of wear of at least the nonadjustable vibration damper. When the nonadjustable vibration damper is worn, then it is highly probable that the adjustable vibration dampers have reached their maximum operating period because the wearing parts are identical in both constructional forms of the vibration damper.

The state of wear is displayed by a display device and the driver is informed so that the vibration damper can be exchanged depending on wear.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 is a schematic view of a two-axle suspension with three adjustable vibration dampers;

FIG. 2 is a schematic view of a two-axle suspension with two adjustable vibration dampers;

FIG. 3 is a schematic view of the damping forces acting on the vehicle suspension;

FIG. 4 is a block diagram showing the operation of the adjustable vibration dampers; and

FIG. 5 is a block diagram for determining the state of wear.

### DETAILED DESCRIPTION OF THE PRESENTLY PREFERRED EMBODIMENTS

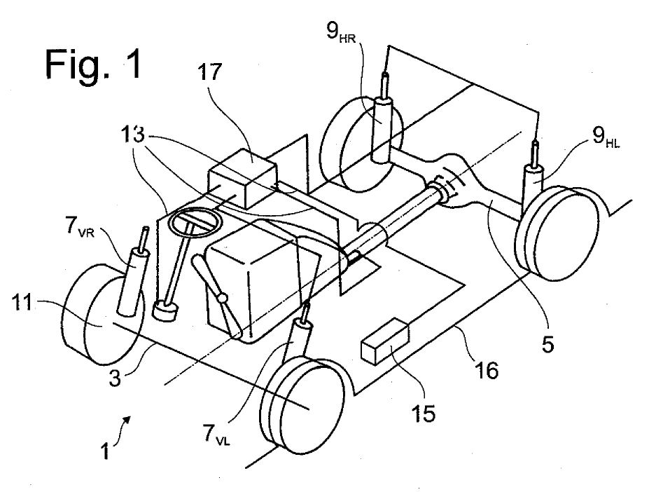

FIG. 1 is a highly simplified rendering of a suspension for a motor vehicle 1 with a front axle 3 and a rear axle 5, although the invention is not limited to a two-axle vehicle. Vibration dampers 7_{VL}; 7_{HR}; 9_{HR}; 9_{HL} which damp a suspension movement of each wheel 11 are arranged at each of the two vehicle axles 3; 5. An adjustable vibration damper 7_{VL}; 9_{HR}; 9_{HL} and a nonadjustable vibration damper 7_{VR} are arranged on at least one axle, in this case the front axle 3.

The motor vehicle has a sensor arrangement 13 which acquires vehicle state parameters, for example, the speed, a steering angle or also the motion of a vehicle body 16, for example, by means of an acceleration sensor 15. All of the signals of the sensor arrangement 13 are fed to a computer unit 17 which generates actuating signals therefrom for the adjustable vibration dampers 7_{VL}; 9_{HR}; 9_{HL}.

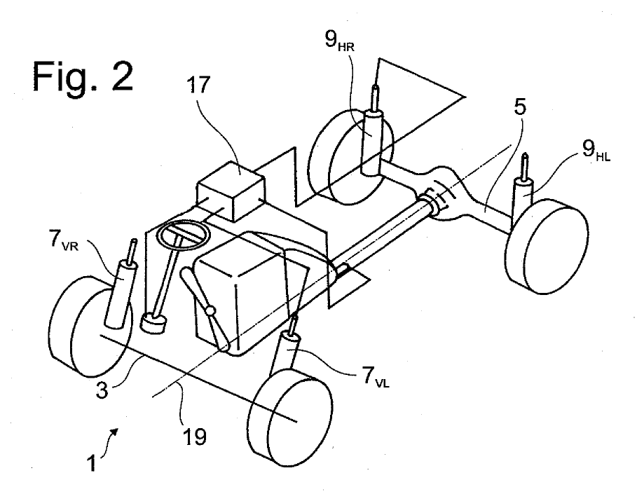

FIG. 2 shows a variant which is still further simplified compared to FIG. 1, in which only one adjustable vibration damper 7_{VL}; 9_{HR} is arranged at each axle 3; 5, but diagonally with respect to a vehicle longitudinal axis 19.

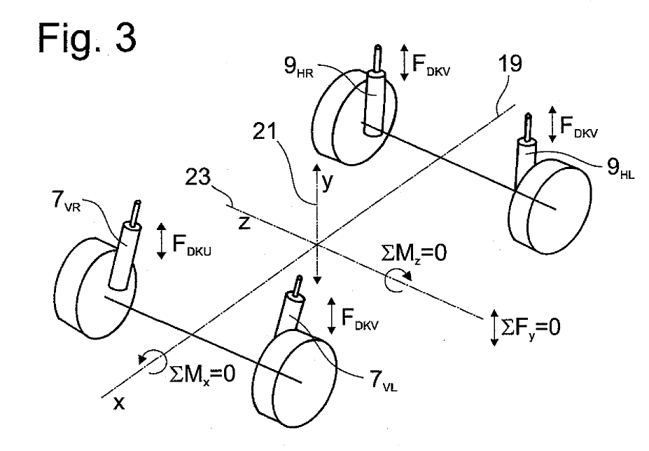

FIG. 3 is limited to the depiction of lines of action of damping forces and the movements of the vehicle body which are dependent upon the driving state. Vertical movements parallel to the vertical axis 21 of the vehicle or the Y-axis cause a lifting and a lowering of the vehicle body 16 parallel to a plane roadway. Opposing damping forces F_{Y} must be used in order to suppress a vibration. Pitching movements such as those occurring, for example, when accelerating or when braking describe turning moments (Mz) around a transverse axis 23 of the vehicle. Rolling movements, e.g., when cornering, are considered as turning moments around the longitudinal axis 19 of the vehicle.

When the driving state is known, it can be determined, e.g., by a vector calculation, which damping forces at the respective vibration damper are useful and/or necessary to dampen a vehicle body movement. In the view based on FIG. 1, only the vibration dampers 7_{VL}; 9_{HL}; 9_{HR} can be adjusted to the driving state.

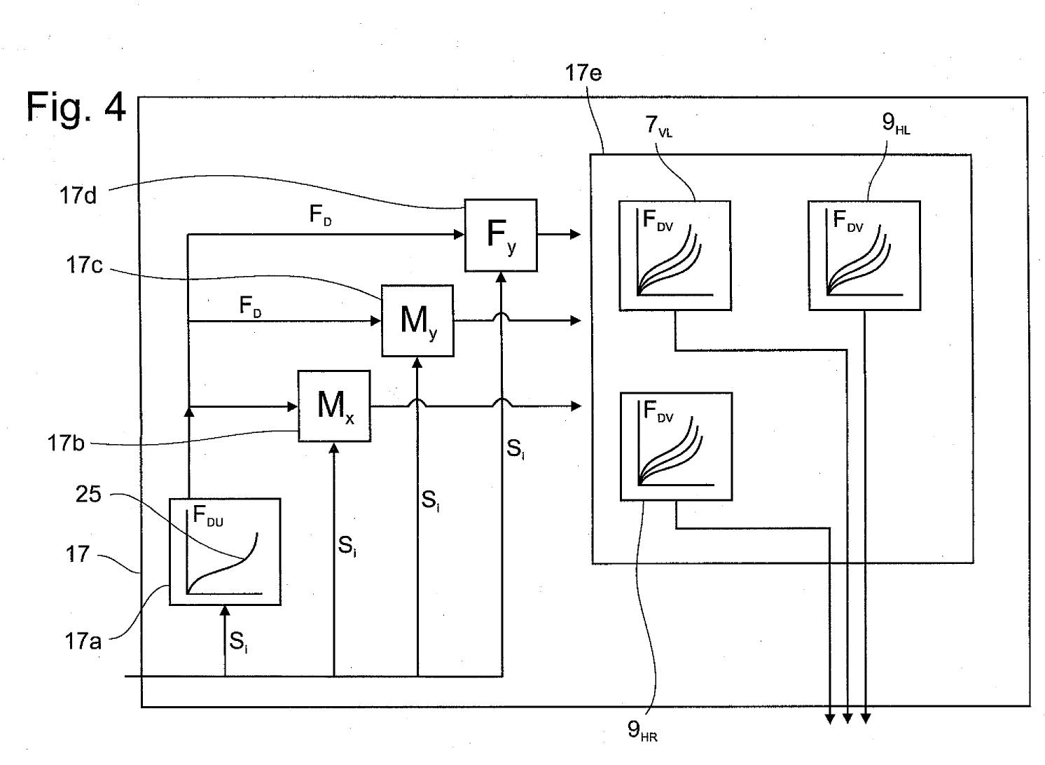

FIG. 4 shows in a highly abstract manner an operating method for the adjustable vibration dampers 7_{VL}; 9_{HR}; 9_{HL} which takes place in the computer unit 17. All of the signals Sᵢ of the sensor arrangement 13 are sent to the computer unit 17. The signals Sᵢ are fed to a first module 17a which serves to determine the damping force of the nonadjustable vibration damper 7_{VR} based on the signals Sᵢ. An invariable damping force characteristic 25 of the nonadjustable vibration damper is stored in the module. The combination of the damping force characteristic 25 and at least one input signal leads to a damping force F_{DU} which is included as damping force component in the ongoing damping force determination of the adjustable vibration dampers. In the present example, damping forces for respective driving states which are related to a corresponding axis according to FIG. 3 are determined in modules 17b-17d. All of the damping forces related to the driving state which are determined in the modules 17b-17d are combined in module 17e to form a total damping force for all driving states. In module 17e, the total damping force for each of the individual adjustable vibration dampers 7_{VL}; 9_{HL}; 9_{HR} is converted to damping forces which can be generated respectively by adjustable vibration dampers 7_{VL}; 9_{HL}; 9_{HR}. The best possible damping force characteristic for each adjustable vibration damper 7_{VL}; 9_{HL}; 9_{HR} is selected from a quantity of possible damping force characteristics.

In a vehicle with a front axle and a rear axle and a total of four adjustable vibration dampers, four unknown damping force vectors are assumed which must be determined with the aim of suspension control/suspension regulation based on the at least one driving state parameter. With the present method, only three unknown damping force vectors need be determined because the fourth damping force vector of the nonadjustable vibration damper is already known by way of the damping force characteristic. This reduces the calculating time. Of course, the computer structure described with reference to FIG. 4 can also be carried out according to another scheme or in other modules for determining the damping forces of the adjustable vibration damper 7_{VL}; 9_{HL}; 9_{HR}.

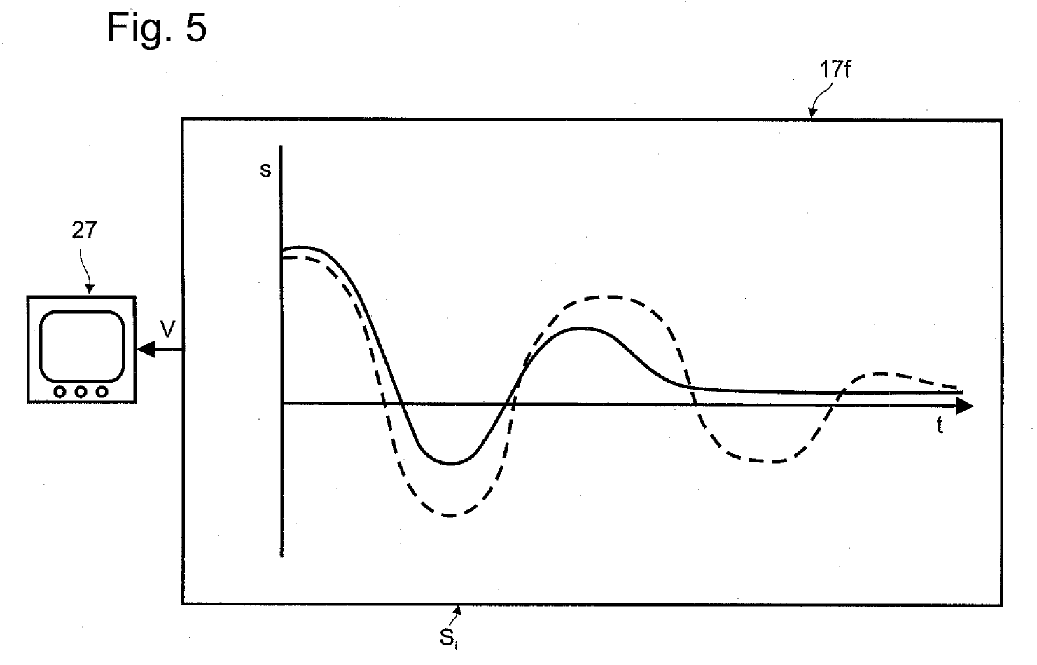

Another function of the method for operating the adjustable vibration dampers is described with reference to FIG. 5. A damping force characteristic FD corresponding to a vibration damper with minimum permissible damping function is provided in module 17a. A decay function, e.g., of a vehicle body movement, can be determined in a module 17f of the computer unit 17 from signals Sᵢ as is shown by the solid line. When this decay function of the damping force adjustment of the adjustable vibration dampers is no longer achieved, as is shown by the dashed line, it must be assumed that one of the vibration dampers of the vehicle is defective because the damping force contribution of the nonadjustable vibration damper is not met. With respect to an adjustable vibration damper, signs of wear V can be compensated within limits by the adjusting function; this effect is not available for a nonadjustable vibration damper. Consequently, it must be assumed from a decay function which lasts longer at the same excitation (compare the dashed line to the solid line) that there is a worn vibration damper. When the nonadjustable vibration damper can no longer generate the minimum damping force, there is a high probability that the adjustable vibration dampers are also no longer functioning properly because the piston rod seal and a piston seal, which are wearing parts in a vibration damper, are again at least comparable regardless of the adjustability of a vibration damper,

The state of wear V of the vibration dampers can be sent to a display 27 so that the driver is informed and can replace them.

The invention is not limited by the embodiments described above which are presented as examples only but can be modified in various ways within the scope of protection defined by the appended patent claims.

We claim:

1. Suspension for a motor vehicle having a front axle, a rear axle, a longitudinal axis, and a transverse axis, the suspension comprising at least two vibration dampers separated by the longitudinal axis on each axle, each vibration damper having a damping force, the sum of the damping forces being adjustable, at least one of the vibration dampers being nonadjustable.

2. The suspension of claim 1 wherein the vibration dampers comprise a pair of adjustable vibration dampers which are diagonally opposed with respect to the longitudinal axis, and a pair of nonadjustable vibration dampers which are diagonally opposed with respect to the longitudinal axis.

3. The suspension of claim 1 further comprising:
a sensor arrangement which acquires at least one vehicle state parameter; and
a computer unit which determines the damping force for the at least one nonadjustable vibration damper on the basis of said at least one vehicle state parameter, and which determines the desired damping forces for the adjustable vibration dampers based on the damping force for the at least one nonadjustable vibration damper and the at least one vehicle state parameter.

4. A method for controlling a suspension for a motor vehicle having a front axle, a rear axle, a longitudinal axis, and a transverse axis, the suspension comprising at least two vibration dampers separated by the longitudinal axis on each axle, each vibration damper having a damping force, the sum of the damping forces being adjustable, at least one of the vibration dampers being nonadjustable, the method comprising:
acquiring at least one vehicle state parameter;
determining the damping force for the at least one nonadjustable vibration damper on the basis of said at least one vehicle state parameter; and
determining the desired damping forces for the adjustable vibration dampers based on the damping force for the at least one nonadjustable vibration damper and the at least one vehicle state parameter.

5. The method of claim 4 wherein the damping force for the at least one nonadjustable vibration damper is determined based on a damping force characteristic, wherein the damping force characteristic is determined based on said at least one vehicle state parameter.

6. The method of claim 4 comprising:
providing a damping force characteristic which represents a minimum permissible damping function;
determining a decay function of an oscillatory motion of the vehicle based on said minimum permissible damping function and at least one said vehicle state parameter; and
determining a state of wear of at least the nonadjustable vibration damper based on a deviation of the decay function from a reference decay function.

7. The method of claim 6 further comprising displaying the state of wear on a display device.
